(19) United States
(12) Patent Application Publication
(10) Pub. No.: US 2025/0047180 A1
(43) Pub. Date: Feb. 6, 2025

(54) METHOD FOR PRODUCING A LAMINATED CORE OF AN ELECTRICAL MACHINE

(71) Applicant: Robert Bosch GmbH, Stuttgart (DE)

(72) Inventor: Martin Koehne, Asperg (DE)

(21) Appl. No.: 18/717,699

(22) PCT Filed: Nov. 14, 2022
(86) PCT No.: PCT/EP2022/081774

§ 371 Date: Jun. 7, 2024

(30) Foreign Application Priority Data
Dec. 8, 2021 (DE) 10 2021 213 936.1

(51) Int. Cl. H02K 15/03; H02K 1/276

(52) U.S. Cl. CPC H02K 15/03; H02K 1/276

(57) ABSTRACT

A method for producing a laminated core (1) of an electrical machine, comprising the steps of a) providing foil laminations (4) each comprising a carrier foil (6) made of aluminum and a natural or produced aluminum oxide layer (7) and each being coated with a first foil coating (10) made of a first powder mixture on at least one side (11, 12) at flux barrier surfaces (8), wherein the first powder mixture comprises an austenite stabilizer, aluminum oxide, and an adhesive agent, b) providing sheet metal laminations (5) of the laminated core (1), c) alternately stacking sheet metal laminations (5) and foil laminations (4), wherein the foil laminations (4) are oriented relative to the sheet metal laminations (5) such that the flux barrier surfaces (8) of the respective foil lamination (4) come into direct contact with the respective sheet metal lamination (5) at specified flux barrier locations (9) of the respective sheet metal lamination (5); d) heating the stack of sheet metal laminations (5) and foil laminations (4) such that
the austenite stabilizer is diffused from the first foil coating (10) of the foil laminations (4) at the respective flux barrier locations (9) into the metal of the respective contacted sheet metal lamination (5), thereby forming a flux barrier (15)
the aluminum is diffused from the carrier foils (6) of the foil laminations (4) into the metal of the respective adjacent sheet metal lamination (5), thereby dissolving the carrier foil.

### BACKGROUND

The invention relates to a method for producing a laminated core of an electrical machine.

EP 3 511 429 A1 discloses a laminated core and a method for its production. In this process, sheet metal layers are coated with a coating containing a mass fraction of at least 20% aluminum and/or silicon. Furthermore, the coated initial laminated core is heat-treated in order to produce the laminated core. In one embodiment, the laminated core produced may have a silicon content corresponding to a mass fraction of at least 6.5%. In another embodiment, a silicon content corresponding to a mass fraction of more than 4% and less than 6.5% can be realized.

### SUMMARY

The method according to the invention with the features of the main claim has the advantage that flux barriers can be formed locally in the sheet metal laminations of the laminated core in a targeted manner. This makes it possible to change the material properties of the webs of a rotor such that they become magnetically non-conductive and thus form a flux barrier. In particular, 3-dimensionally shaped flux barriers can be formed by the stacked structure of the sheet metal pack.

According to the invention, this is achieved with the following process steps:

In a first step 1a), foil laminations are provided, each comprising a carrier foil made of aluminum and a natural or produced aluminum oxide layer and each being coated on at least one side at flux barrier surfaces with a first foil coating made of a first powder mixture, wherein the first powder mixture comprises an austenite stabilizer or eutectoid former, in particular manganese and/or nickel and/or cobalt, an electrical insulator compound, in particular aluminum oxide or silicon oxide (SiO2), and an adhesive agent. The first foil coating is applied to the areas that are to be formed as flux barriers after the subsequent heat treatment.

In a subsequent second step 1b), sheet metal laminations of the laminated core are provided, which are in particular electrically uninsulated, i.e., have no paint coating.

In a subsequent third step 1c), the sheet metal laminations and foil laminations are stacked alternately, wherein the foil laminations are oriented relative to the sheet metal laminations, in particular with respect to the rotary bearing, such that the flux barrier surfaces of the respective foil lamination come into direct contact with the respective sheet metal lamination at specified flux barrier locations of the respective sheet metal lamination.

In a subsequent fourth step 1d), the stack of sheet metal laminations and foil laminations is heated, in particular heat-treated, such that
the austenite stabilizer is diffused from the first foil coating of the foil laminations into the metal of the respective contacted sheet metal lamination at the flux barrier locations, thereby forming a flux barrier,
the aluminum is diffused from the carrier foils of the foil laminations into the metal of the respective adjacent sheet metal lamination, thereby dissolving the carrier foil. The aluminum content between the surface and core of the sheet metal lamination may decrease.

In this way, a non-magnetizable austenite phase is formed at the flux barrier locations.

The measures listed in the dependent claims enable advantageous further embodiments of the method specified in the main claim.

It is particularly advantageous if the first powder mixture also comprises an electrically insulating insulator compound, in particular aluminum oxide or silicon oxide (SiO2), and/or an alloy material, in particular silicon, as this simultaneously creates an insulating layer between the respective adjacent sheet metal lamination in the area of the flux barrier surfaces of the respective foil lamination and/or additionally alloys the respective adjacent sheet metal lamination in the area of the flux barrier surfaces.

It is also advantageous if, in step 1a), the foil laminations are each coated on insulation surfaces with at least a second foil coating made of a second powder mixture on a side coated with the first foil coating. The second powder mixture contains an electrically insulating insulator compound, in particular aluminum oxide or silicon oxide (SiO2), and an adhesive agent. In this way, the creation of a complete insulation layer between adjacent, in particular uninsulated, sheet metal laminations is prepared.

It is very advantageous if, in step 1d), heating is carried out such that the insulator compound, in particular from the first and/or second foil coating of the foil laminations and/or from the aluminum oxide layer, remains between the sheet metal laminations after heating, forming in each case an insulating layer between adjacent sheet metal laminations, wherein the respective insulating layer is formed in the region of the insulating surfaces and in particular in the region of the flux barrier surfaces or the flux barriers. This method of creating an insulation layer between adjacent sheet metal laminations makes it possible to use the flux barriers produced in the laminated core.

It is also advantageous if the adhesive agent is provided for adhering the first or second powder mixture to the carrier foil of the respective foil lamination and is in particular a paste and/or a polysaccharide, in particular xanthan gum and/or amylopectin. In order to achieve a secure bond between the powder and the foil lamination, powder mixtures consisting of aluminum oxide powder or manganese powders and aluminum oxide powders can be mixed with water and xanthan gum, for example. At least one side of the foil lamination can then be coated with this mixture using a compressed air spray gun, for example. A corresponding stencil can be used to cover part of the respective sheet metal lamination so that when coating with the manganese-containing powder mixture, only those areas are coated that will later serve as a flux barrier. In the case of the non-manganese-containing powder mixture, a stencil is then preferably used that only covers the areas of the flux barriers. The water evaporates during subsequent drying. The xanthan gum remaining in the mixture ensures that the powders adhere well. The other side of the foil lamination can then be coated in the same way.

According to one exemplary embodiment, the shape and/or surface of the foil laminations correspond to the shape and/or surface of the sheet metal laminations. The foil laminations can be punched to the same shape as the sheet metal laminations before they are stacked to form the laminated core. Preferably, however, unpunched foil laminations and punched sheet metal laminations are stacked alternately on top of each other to form the laminated core and the protruding aluminum foil is removed after stacking is complete. As the aluminum foil is very thin, this only requires a small amount of effort. In another possible embodiment, there is no need to remove the protruding foil, as it melts and drips off during heat treatment.

It is also advantageous if the first powder mixture comprises a further substance which is suitable for forming a eutectic, in particular with a melting temperature <1300° C., with the austenite stabilizer. For forming the eutectic with the austenite stabilizer, tin in particular is provided for forming a eutectic with nickel, since nickel does not form a eutectic with iron.

A eutectoid former can advantageously promote the formation of austenite from the liquid phase down to such low temperatures that decomposition into two phases no longer occurs during further cooling and the austenite is therefore also present at room temperature. The eutectoid former is based on copper and/or zinc and/or carbon and/or nitrogen.

The austenite stabilizer is diffused into the iron during heat treatment so that austenite is formed instead of other modifications, in particular instead of ferrite. A high concentration can be provided locally, so that the austenite stabilizer is diffused into the core from two sides of the respective sheet metal lamination in particular. The additional substance for forming a eutectic can advantageously lower the melting point of, for example, manganese, nickel or cobalt or a mixture of these austenite stabilizers. It is also conceivable that only the eutectoid formers copper and/or zinc and/or carbon and/or nitrogen are used to bring about the formation of austenite. However, carbon has the disadvantage that it is very diffusible, while nitrogen has the disadvantage that it is very inert to diffusion.

Advantageously, a multi-stage heat treatment under hydrogen can be provided. Advantageously, a further heat treatment of the sheet metal laminations preceding the heat treatment with the coated foil laminations arranged therebetween is carried out in a range from about 150° C. to about 500° C. for about one to about two hours. In particular, this can be carried out at 400° C. In this first stage, the xanthan gum can be decomposed to water, carbon monoxide, carbon dioxide and methane and thus removed. In the next stage, which provides for heat treatment in a range of 950° C. to 1250° C., preferably 1000° C. to 1100° C., for in particular 1 to 24 hours, diffusion of the austenite stabilizer, in particular the manganese, and the aluminum into the sheet metal lamination takes place. When the austenite stabilizer and the aluminum have completely diffused in, the electrically insulating solid, such as an aluminum oxide powder, remains between the sheet metal laminations as an electrically insulating layer.

In one possible embodiment, the cost-effective production of a laminated core with intrinsic flux barriers and very good electrical insulation between the individual sheet metal laminations is possible. In an advantageous way, the formation of local intrinsic flux barriers in the sheet metal laminations can be achieved by the at least one austenite stabilizer diffused into the sheet metal laminations. Preferably, the local intrinsic flux barriers extend over a thickness of the respective sheet metal laminations. An intrinsic flux barrier is created by the respective sheet metal laminations locally losing its ferromagnetic properties and thus also its very high permeability or at least significantly reducing these. In addition, the electrical insulation between the sheet metal laminations can be ensured at the same time.

In contrast to a conventional embodiment, in which flux barriers are realized by omitting electrical sheet metal, for example by providing slots or locally reducing a thickness by embossing, the mechanical stability of the sheet metal laminations can thus be improved. In particular, this enables a higher maximum speed and improves the vibration resistance of the laminated core, especially with respect to the rotor. Furthermore, the design of a magnetic flux circuit can be improved in an advantageous way and, in particular, a freer design can be made possible without the need for significantly higher manufacturing costs.

In this way, the austenite stabilizer enables paramagnetic austenite in an advantageous way, thus avoiding the formation of ferromagnetic and therefore highly permeable ferrite. In the areas into which the austenite stabilizer has diffused, the paramagnetic austenite is stable up to room temperature.

The powdered austenite stabilizer can advantageously be part of a powder mixture with the insulating solid, in particular a silicon dioxide, and possibly other substances, in particular a silicon alloy material. The coated aluminum foils are preferably cut into foil laminations that are large enough to completely cover each individual sheet metal lamination. When stacking the sheet metal laminations for the electrical sheet of a rotor or stator, a piece of foil is preferably placed for each sheet metal lamination placed on the stack. The resulting stack then advantageously consists of alternating sheet metal laminations and foil laminations stacked on top of each other. During the subsequent heat treatment, diffusion is achieved in accordance with the presence of the austenite stabilizer, silicon or aluminum in the aluminum foil, wherein the electrically insulating powder remains as an electrically insulating layer between adjacent sheet metal laminations.

In one possible embodiment, the aluminum foil can be coated with at least two different powder mixtures, wherein both powder mixtures contain the powder of an inorganic electrical insulator. At least one of the powder mixtures preferably contains at least one austenite stabilizer. The coated aluminum foils can then be stacked alternately with sheet metal laminations to form a laminated core. This is followed by a heat treatment in which the aluminum and the austenite stabilizer diffuse into the sheet metal laminations. The insulating powder remains between adjacent sheet metal laminations as an electrically insulating layer. The coating can be applied by spraying, brushing or printing, for example.

Suitable substances for the austenite stabilizer are substances that preferably strongly favor the formation of austenite when cooled above 1200° C. Further requirements may be that such an austenite stabilizer is stable against a hydrogen atmosphere and diffuses into the iron of the sheet metal laminations at at least 1200° C. Manganese, nickel and cobalt are particularly preferable, but also copper, which forms a eutectoid down to temperatures so low that the austenite can no longer decompose into other phases. Furthermore, it is advantageous if the austenite stabilizer is applied together with a further substance that is neutral with regard to the formation of ferrite or austenite, but forms a eutectic with the austenite stabilizer, which has a melting temperature of less than 1300° C. in particular. However, such a further substance can also be an austenite stabilizer, which is less effective.

Suitable materials for the electrically insulating powder are electrically insulating solids that are preferably stable up to at least 1250° C. in a water atmosphere and do not melt. In a hydrogen atmosphere, a significant reduction of aluminum oxide by a maximum mass fraction of 20% does not occur until 1300° C. At a heat treatment temperature of 1250° C., a maximum of 7% of the aluminum oxide is reduced. Silicon oxide (SiO₂) and mullite (AI(4+2x)Si(2-2x)O(10-x) wherein x=0.17 to x=0.59) are also stable in a strongly reducing water atmosphere up to 1250° C. and do not melt, so that they are also suitable as electrically insulating solids.

An aluminum foil can, for example, have a foil thickness of 5 m and be printed on both sides with either a mixture of manganese powder and aluminum oxide powders or only with aluminum oxide powders, depending on the desired flow barrier geometry in one embodiment. The manganese powder can be composed of manganese nanopowder with a grain size of between around 30 and 50 nm and/or a manganese powder with an average particle size of 1 to 5 m. An aluminum oxide powder can have an average particle size of 3 m or even 40 nm, for example. However, depending on the application and availability, other grain sizes can also be used for the manganese powder or the manganese nanopowder and the aluminum oxide powder. The same applies to other materials.

In this way, laminated cores with advantageous properties can be realized in a cost-effective manner. In particular, this makes the realization of very powerful electric motors, which are used for electric vehicles, electric bicycles or hybrid drives, for example, possible in an economical manner.

### BRIEF DESCRIPTION OF THE DRAWINGS

Preferred exemplary embodiments of the invention are explained in more detail in the following description with reference to the accompanying drawings in which corresponding elements are provided with the same reference numerals.

Shown are:

FIG. 1 a schematic illustration of a laminated core before heat treatment;

FIG. 2A a partial view of the laminated core according to FIG. 1 according to a detail II in FIG. 1;

FIG. 2B a partial view of the laminated core according to FIG. 1 according to detail II in FIG. 1 after heat treatment;

FIG. 3 a partial view of the laminated core corresponding to a viewing direction III in FIG. 2B;

FIG. 4A a phase diagram illustrating the invention, wherein a diagram for an austenite stabilizer is shown;

FIG. 4B a phase diagram illustrating the invention wherein a diagram for a eutectoid former is shown; and

FIG. 4C a phase diagram illustrating the invention wherein a diagram for a ferrite former is shown.

### DETAILED DESCRIPTION

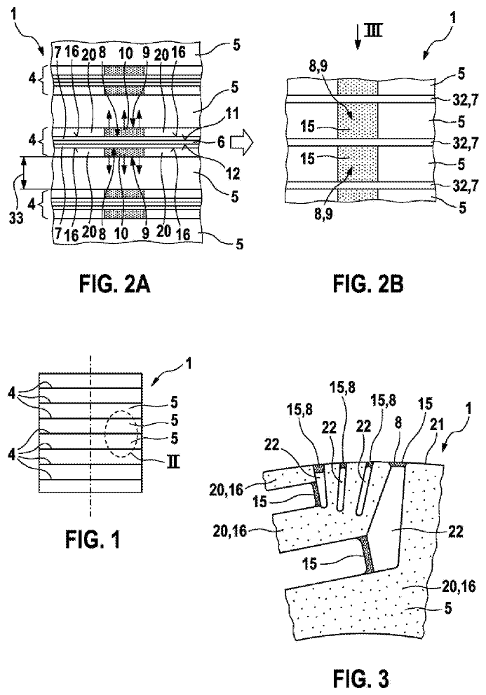

FIG. 1 shows a schematic illustration of a laminated core 1 before heat treatment.

FIG. 2A shows a partial view of the laminated core according to FIG. 1 according to a detail II in FIG. 1.

FIG. 2B shows a partial view of the laminated core according to FIG. 1 according to detail II in FIG. 1 after heat treatment.

A laminated core 1 comprises a plurality of stacked sheet metal laminations 5 based on a ferrous material. Here, FIG. 1 shows a state of the laminated core 1 before heat treatment. The laminated core 1 can be a laminated core of a rotor or stator of the electrical machine. The laminated core 1 is cylindrical in shape.

FIG. 2A and FIG. 2B show the laminated core 1 before and after heat treatment, respectively, according to a possible embodiment in a schematic illustration.

According to the invention, the following process steps are carried out to produce the laminated core 1:

In a first step 1a), foil laminations 4 are provided, each comprising a carrier foil 6 made of aluminum, that is, an aluminum foil 6, and a natural or produced aluminum oxide layer 7, and each being coated on at least one side 11, 12 at flux barrier surfaces 8 with a first foil coating 10 made of a first powder mixture, wherein the first powder mixture comprises an austenite stabilizer, in particular manganese and/or nickel and/or cobalt, aluminum oxide and an adhesive agent.

In a second step 1b), sheet metal laminations 5 of the laminated core 1, which are in particular electrically uninsulated, are provided. The sheet metal laminations 5 are made of electrical sheet. The shape and/or the surface of the foil laminations 4 can correspond to the shape and/or surface of the sheet metal laminations 5.

In a third step 1c), the sheet metal laminations 5 and foil laminations 4 are alternately stacked, wherein the foil laminations 4 are oriented relative to the sheet metal laminations 5 such that the flux barrier surfaces 8 of the respective foil lamination 4 come into direct contact with the respective sheet metal lamination 5 at specified flux barrier locations 9 of the respective sheet metal lamination 5.

In a fourth step 1d), the stack of sheet metal laminations 5 and foil laminations 4 is heated, for example with a heat treatment in an oven. According to the invention, the heating is carried out such that
the austenite stabilizer is diffused from the first foil coating 10 of the foil laminations 4 into the metal of the respective contacted sheet metal lamination 5 at the flux barrier locations 9, thereby forming a flux barrier 15 in the sheet metal lamination 5,
the aluminum is diffused from the carrier foils 6 of the foil laminations 4 at a certain depth into the metal of the respective adjacent sheet metal lamination 5, thereby dissolving the carrier foil 6.

The first powder mixture may additionally comprise an electrically insulating insulator compound, in particular aluminum oxide or silicon oxide (SiO2), and/or an alloy material, in particular silicon.

In addition, it may be provided that in step 1a) the foil laminations 4 are each additionally coated, in each case on insulator surfaces 16, with at least one second foil coating 20 made of a second powder mixture on one coated side 11, 12 in which the magnetic flux is to be obtained, wherein the second powder mixture has, in each case, an electrically insulating insulator compound, in particular aluminum oxide or silicon oxide (SiO2), and an adhesive agent. Heating in step 1d) then takes place such that the insulator compound, in particular from the first and/or second foil coating 20 of the foil laminations 4 and/or from the aluminum oxide layer 7, remains between the adjacent sheet metal laminations 5 after heating is complete, wherein the respective insulator layer 32 can be formed in the region of the insulating surfaces 16 and additionally in particular in the region of the flux barrier surfaces 8 or the flux barriers 15.

The adhesive agent of the first and second powder mixture serves to adhere the first or second powder mixture to the carrier foil 6 of the respective foil lamination 4 and can, for example, be a paste and/or a polysaccharide, in particular xanthan gum.

Some exemplary embodiments of the invention are described below:

Before the heat treatment, an aluminum-based foil lamination 4, which can be cut from an aluminum foil, for example, is inserted between the sheet metal laminations 5 when the sheet metal laminations 5 are stacked. The aluminum foil from which the foil lamination 4 originates is preferably provided or coated on both sides with a natural or produced aluminum oxide layer 7, for example. The aluminum oxide layer 7 is continuous. Furthermore, at least a first coating 10 with the austenite stabilizer is provided on both sides, which is only partially applied. In this exemplary embodiment, the foil lamination 4 has upper sides 11, 12 on which the first coatings 10 with the austenite stabilizer are applied. Furthermore, in areas where the first coating 10 is not applied, a second coating 20 is applied, which may comprise an alloy material based on silicon, for example.

A foil laminations 4, which has at least one aluminum oxide layer 7, is arranged between adjacent sheet metal laminations 5 of the laminated core 1. Furthermore, a first coating 10 with, for example, manganese as an austenite stabilizer is applied to the foil laminations 4. Where no manganese is applied to the respective piece of foil 4, the second coating 20 with silicon as an alloy material may be applied.

The respective first foil coating 10 is applied to the foil lamination 4 in such a way that the austenite stabilizer and/or eutectoid former and/or former of a eutectic with the austenite former can be diffused into the material of the respective foil lamination 5 by heat treatment through the arrangement of the respective foil lamination 4 between two of the sheet metal laminations 5 of the laminated core 1 at the flux barrier locations 9 of the respective sheet metal lamination 5.

After the heat treatment, a zone with diffused manganese, a zone with diffused silicon and aluminum and an aluminum oxide layer 32 remaining between the sheet metal laminations 5 can result in the sheet metal laminations 5.

As illustrated in FIG. 2B, an insulating layer 32 remains between the sheet metal laminations 5 after the heat treatment. The insulating layer 32 results from the electrically insulating solids remaining between the sheet metal laminations 5. The aluminum of the carrier foil 6 of the foil lamination 4 is diffused together with the silicon into the sheet metal laminations 5, wherein an average penetration depth results at each of the sheet metal laminations 5. As a result, the sheet metal laminations 5 are formed at least close to the surface with an alloyed ferrous material or a higher alloyed ferrous material. The austenite stabilizer from the first coating 10 also diffuses into the sheet metal laminations 5, wherein diffusion also occurs from (not shown) further foil laminations 4 on both sides, so to speak. A corresponding concentration of the austenite stabilizers results in a flux barrier 15 in the sheet metal laminations 5 and a flux barrier 14 in the adjacent sheet metal laminations 5 over the entire thickness 33 of the sheet metal laminations 5.

The austenite stabilizer or the austenite stabilizers of the first coating 10 are based on manganese and/or nickel and/or cobalt and/or copper. Preferably, a further substance can be used here which forms a eutectic in order to lower the melting point, but at the same time supports the formation of austenite or only barely influences it. These substances, in particular the electrically insulating solid and the austenite stabilizer, are preferably in powder form and are applied to the upper sides 11, 12 of the foil laminations 4 by means of an adhesive agent and/or by means of a polysaccharide, in particular xanthan gum or amylopectin. This does not necessarily require separation into individual layers, as shown in FIG. 1. This means that, on the one hand, the alloy material, in particular silicon, can also be mixed with the electrically insulating solid and then partially applied to the upper sides 11, 12 of the foil laminations 4 by means of the adhesive agent and/or the polysaccharide. On the other hand, the austenite stabilizer can be mixed with the electrically insulating solid and applied to the remaining parts. A different sequence is also possible here.

FIG. 3 shows a partial view of the laminated core corresponding to a viewing direction III in FIG. 2B.

The austenite stabilizer is applied to the foil laminations 4 in such a way that it forms flux barriers 15 at flux barrier locations 9 on the respective sheet metal laminations 5. In this exemplary embodiment, the flux barriers 15 are formed in or on webs 16 of the sheet metal laminations 5. The webs 16 are formed, for example, by recesses 22 in the respective sheet metal laminations 5. The recesses 22 can, for example, be located near a circumference 21 of the laminated core 1.

Thus, flux barriers 15 can be formed locally in the sheet metal laminations 5, which are intrinsic, for example. These flux barriers 15 enable significant improvements in the design and functionality.

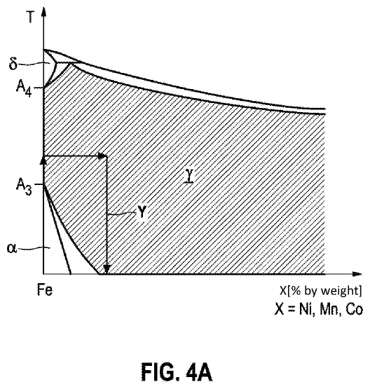

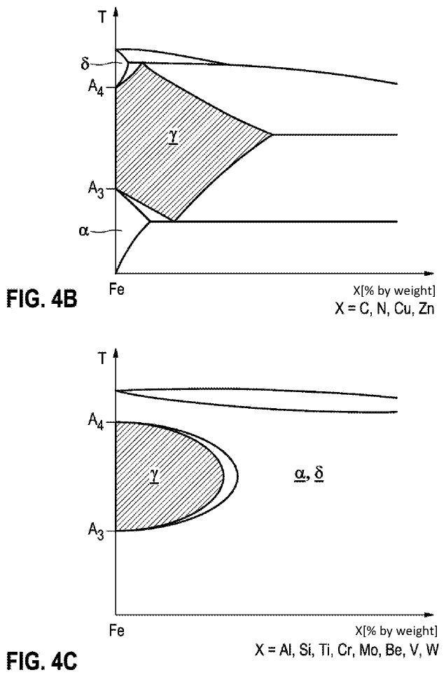

FIGS. 4A, 4B and 4C illustrate the influence of suitable alloying elements X on the size of the respective austenite region in the respective phase diagram of FeX. The concentration of the respective alloying element X in % by weight is shown on the x-axis, while the temperature T is shown on the y-axis.

FIG. 4A shows a phase diagram illustrating the invention, wherein a diagram for an austenite stabilizer is shown. Using manganese as an austenite stabilizer, the austenite phase (gamma), as shown in the outlined phase diagram, becomes stable at increasingly lower temperatures with increasing concentration of manganese. The lower temperature limit shown in the diagram is room temperature.

FIG. 4A shows an exemplary process according to the invention along a line Y, which illustrates the effect of austenite stabilization during heat treatment. By diffusing the austenite stabilizer into the respective sheet metal laminations 5, the austenite of the heated sheet metal laminations 5 is stabilized in such a way that when the sheet metal laminations 5 cools down, the austenite is not converted back into ferrite according to the phase diagram.

FIG. 4B shows a phase diagram illustrating the invention, wherein a diagram for a eutectoid former is shown.

Due to copper as a eutectoid former, the austenite phase, as shown in the phase diagram, becomes stable at lower temperatures as the concentration of copper increases. However, stability down to room temperature cannot be achieved. Rather, at a certain copper concentration, a minimum occurs for the temperature at which the austenite phase is still stable. This region, in which austenite is stable even at low temperatures well below A3, enables the austenite to virtually freeze during cooling and thus to be preserved during further cooling down to room temperature. Thereafter, the temperature up to which the austenite phase is stable increases as the concentration of copper continues to rise. This makes it increasingly difficult to virtually freeze the austenite during cooling and ultimately this is no longer possible. A further increase in the copper concentration leads to the concentration at which the formation of an austenite phase in the iron is no longer possible.

FIG. 4C shows a phase diagram illustrating the invention wherein a diagram for a ferrite former is shown.

Ferrite formers such as silicon or aluminum make ferrite (alpha) the stable phase at room temperature, as shown in the sketched phase diagram. This means that the austenite is only stable if there is a low concentration of the ferrite former and a high temperature at the same time. Therefore, the austenite cannot freeze during cooling, as it transforms into ferrite when the temperature is still high.

The invention is not limited to the exemplary embodiments described.

1. A method for producing a laminated core (1) of an electrical machine comprising the steps of:
a) providing foil laminations (4), each comprising a carrier foil (6) made of aluminum and a natural or produced aluminum oxide layer (7) and each being coated with a first foil coating (10) made of a first powder mixture on at least one side (11, 12) at flux barrier surfaces (8), wherein the first powder mixture comprises an austenite stabilizer,
b) providing sheet metal laminations (5) of the laminated core (1),
c) alternately stacking sheet metal laminations (5) and foil laminations (4), wherein the foil laminations (4) are oriented relative to the sheet metal laminations (5) such that the flux barrier surfaces (8) of the respective foil lamination (4) come into direct contact with the respective sheet metal lamination (5) at specified flux barrier locations (9) of the respective sheet metal lamination (5);
d) heating, of the stack of sheet metal laminations (5) and foil laminations (4) such that
the austenite stabilizer is diffused from the first foil coating (10) of the foil laminations (4) at the respective flux barrier locations (9) into the metal of the respective contacted sheet metal lamination (5), thereby forming a flux barrier (15)
the aluminum is diffused from the carrier foils (6) of the foil laminations (4) into the metal of the respective adjacent sheet metal lamination (5), thereby dissolving the carrier foil (6).

2. The method according to claim 1, wherein the first powder mixture additionally comprises an electrically insulating insulator compound and/or an alloy material.

3. The method according to claim 1, wherein in step 1a) the foil laminations (4) are in each case additionally coated on insulation surfaces (16) with at least one second foil coating (20) made of a second powder mixture on the coated side (11, 12), wherein the second powder mixture has, in each case, an electrically insulating insulator compound, and an adhesive agent.

4. The method according to claim 2, wherein the heating in step 1d) is carried out such that the insulator compound, from the first and/or second foil coating (20) of the foil laminations (4) and/or from the aluminum oxide layer (7), remains between the sheet metal laminations (5) after heating, in each case forming an insulating layer (32) between adjacent sheet metal laminations (5), wherein the respective insulating layer (32) is formed in the region of the insulating surfaces (16) and in the region of the flux barrier surfaces (8) or the flux barriers (15).

5. The method according to claim 1, wherein the adhesive agent is provided for adhering the first or second powder mixture to the carrier foil (6) of the respective foil lamination (4) and is a paste and/or a polysaccharide.

6. The method according to claim 1, wherein the shape and/or surface of the foil laminations (4) correspond to the shape and/or surface of the sheet metal laminations (5).

7. The method according to claim 1, wherein the first powder mixture comprises a further substance which is suitable for forming a eutectic, with a melting temperature <1300° C., with the austenite stabilizer.

8. The method according to claim 7, wherein the eutectoid former promotes the formation of austenite from the liquid phase down to low temperatures such that the austenite is also present at room temperature, and is based on copper and/or zinc and/or carbon and/or nitrogen.

9. The method according to claim 1, wherein, in order to decompose the adhesive agent of the first and/or second foil coating (10, 20), a further heat treatment of the sheet metal lamination (5) with the coated foil laminations (4) arranged therebetween is carried out in a range from about 150° C. to about 500° C. in a hydrogen-containing atmosphere for about one to about two hours, preceding the heat treatment.

10. The method according to claim 1, wherein the first powder mixture comprises manganese and/or nickel and/or cobalt.

11. The method according to claim 1, wherein the first powder mixtures comprises aluminum oxide.

12. The method according to claim 1, wherein the first powder mixture comprises an adhesive agent.

13. The method according to claim 1, wherein the sheet metal laminations (5) are uninsulated.

14. The method according to claim 1, wherein the heating is heat treatment.

15. The method of claim 2, wherein the first powder mixture comprises aluminum oxide or silicon oxide (SiO2).

16. The method of claim 2, wherein the alloy material is silicon.

17. The method of claim 3, wherein the electrically insulating insulator compound is aluminum oxide or silicon oxide (SiO2).

18. The method of claim 5, wherein the adhesive agent is xanthan.

19. The method of claim 5, wherein the adhesive agent is amylopectin.

20. The method of claim 7, wherein the further substance is tin.
